(19) United States
(12) Patent Application Publication
(10) Pub. No.: US 2008/0291831 A1
(43) Pub. Date: Nov. 27, 2008

(54) Dynamic Management of Wireless Transmissions

(75) Inventors: Yaron Alpert, Hod Hasharon (IL); Yonah Lasker, Jerusalem (IL); Dan Stopler, Halon (IL); Tal Kaitz, Kiryat Ono (IL); Ran Yaniv, Kfar-Saba (IL)

Correspondence Address: BROWDY AND NEIMARK, P.L.L.C.;624 NINTH STREET, NW, SUITE 300, WASHINGTON, DC, 20001-5303, US

(73) Assignee: Alvarion Ltd., Tel-Aviv (IL)

(21) Appl. No.: 11/994,097

(22) PCT Filed: Jun. 21, 2006
(86) PCT No.: PCT/IL06/00717

§ 371 Date: Jul. 21, 2008

(30) Foreign Application Priority Data
Jun. 27, 2005 (IL) 169418

(51) Int. Cl. H04L 12/28; H04Q 7/34; H04L 12/24

(52) U.S. Cl. 370/236

(57) ABSTRACT

There is provided a method and devices for dynamically controlling transmission of communications in a wireless network, which comprises a managing entity and a managed entity that communicate which each other. The managed entity transmits updating information that includes indications of current resources available thereat and/or indications that relate to the reception of communications transmitted by the managing entity. A reporting rate for transmitting the updating information by the managed entity to the managing entity is then determined, and based on the reporting rate that has been determined—modifying, if required, parameters associated with the wireless link extending between the two entities so as to affect changes in the operating conditions at one or both of these entities.

### FIELD OF THE INVENTION

The present invention relates to operation and administration of digital communications and in particular, to methods and apparatus for increasing transmission efficiency in wireless communications systems.

### BACKGROUND OF THE INVENTION

The use of wireless communications has been growing at an exceptional rate, and is predicted to continue to grow, with no end in sight, as more and more data is being sent over the airwaves. The increased availability of wireless web contact and wireless messaging has placed increasing pressure on service providers.

While the demand for data access over wireless communications networks continues to escalate, the available bandwidth and quality of service provided by present wireless communications technology has not kept pace. Moreover, network complexity and diversity has increased, making the challenge of maintaining quality of service for wireless data networks, applications, and services even more difficult. As a result, network access is often delayed or even unavailable during peak usage periods, and connections are often dropped. It is predicted that these types of problems will only grow worse, leaving customers frustrated and unsatisfied. At the same time, there is a need to maintain the bandwidth which is directly translated to operating expenses to the operators, hence there is a very well known strive to improve the transmission efficiency for wireless communications, but without impacting the quality of the service provided.

A number of solutions were suggested in the past in the attempt to improve the current situation.

U.S. Pat. Nos. 6,349,091 and 6,385,174 disclose methods for reducing communication protocol overhead traffic by using controlling communication links in wireless networks. The wireless networks related to in this reference, include nodes arranged into clusters. Each of the clusters has cluster member nodes and a designated cluster head node. The nodes communicate with each other via an intranet protocol, while the network the network may communicate with other external networks in accordance with an internetworking protocol. Link-state advertisement and other routing control packets are transmitted via selective enabling of control links for transferring the packets between network nodes, and at each network head node, there is a database that contains link information for that node that is updated by the information retrieved from the link status advertisement packets. Routing control packets are transmitted to each head node to control routing functions and enable each database to maintain current information. In order to reduce overhead traffic due to transmission of numerous link-status advertisements and other routing control packets, U.S. Pat. No. 6,349,091 suggests selectively controlling the control links (e.g., links that transport routing control information) to transmit the link-status advertisements and other routing control packets to head nodes within the network, while U.S. Pat. No. 6,385,174 proposes transmitting the packets within an intranet protocol beacon type.

U.S. Pat. No. 6,522,628 describes a method for managing transmission resources in a wireless communications network, by receiving a packet and determining a time duration for transmission of the packet. A power level for transmission of the packet over the time duration is further determined, and based on the time duration and the power level, a wireless resource impact is determined for the packet. The transmission resources are allocated based on the wireless resource impact.

U.S. Pat. No. 6,894,985 discloses a method implemented in a mobile ad hoc network, for monitoring link quality at each node, recording transmission information for transmissions on links to neighboring nodes, calculating a packet error rate for each of the links to the neighboring nodes based upon the recorded transmission information, and determining link quality for each of the links to the neighboring nodes based upon the calculated packet error rate.

U.S. Pat. No. 6,421,527 describes a method for dynamic adaptation of wireless communication between a mobile station and a base station, wherein the transmitted frame from the mobile station includes a convolutionally coded portion containing a down-link measurement bit and a repetition code identifying the codec mode of the frame. The transmitted frame from the base station includes a codec mode command signal for the mobile station in the convolutionally encoded portion and the repetition code identify the codec mode of the down-link frame. The base station analyzes the quality of the up-link frame and upon receiving the down-link measurement bit is able to determine the down-link quality.

U.S. Pat. No. 6,088,588 describes a wireless terminal that is operative to monitor its communications with a wireless network in order to provide the network with performance information. The terminal monitors its own operations and messages, or expected messages from the network, and stores information as to the success or failure of these various events. The terminal is further adapted to transmit information to a network at regular time periods or as a response to a request from the network.

U.S. Pat. No. 5,694,451 relates to a method and an arrangement for terminal-oriented performance monitoring. In accordance with this reference, information relating to the network performance is collected by the subscriber terminals in order to provide the network operator with a picture of the performance from the point of view of the customer, in order to enable the operator to operate the network more effectively.

However, none of the methods described in the prior art has proposed an adequate solution to dynamically achieve a maximal effective reporting ratio based on performances monitoring and reporting ratio, thereby increasing the overall efficiency of wireless transmissions.

The disclosure of the references mentioned throughout the present specification are hereby incorporated herein by reference in their entireties and for all purposes.

### SUMMARY OF THE INVENTION

It is an object of the present invention to provide a method and apparatus to increase the transmission efficiency in wireless networks.

It is another object of the present invention to provide a method and an apparatus to reduce the overhead transmission used in wireless networks to provide the base station with information relating to the subscriber terminal status.

Other objects of the invention will become apparent as the description of the invention proceeds.

According to one embodiment of the present invention there is provided a method for dynamically controlling transmission of communications for use in a wireless network comprising at least one managing entity and at least one managed entity communicating which each other along a wireless link extending therebetween. The method comprises the following steps:

from the at least one managed entity, transmitting along the wireless link updating information that comprises indications of current resources available at the managed entity and/or indications that relate to the reception of communications transmitted by the managing entity;

determining at least one reporting rate by which the managed entity should be transmitting information updates to the managing entity; and

based on the at least one reporting rate, determining if required to modify parameters associated with that wireless link, and if in the affirmative, modifying the parameters so as to affect changes in the operating conditions at one or both ends of the wireless link.

According to another embodiment of the invention, the step of determining the at least one reporting rate also comprises notifying the managed entity of the at least one reporting rate, preferably defining when the next information update(s) should be transmitted, until further notification is received by the managed entity.

By yet another embodiment of the present invention, the managed entity is adapted to modify its at least one reporting rate, based on its current available resources and/or based on parameters relating to the reception of communications transmitted by the managing entity.

According to a preferred embodiment of the invention, the updating information (e.g. link status) comprises information that relates to at least one of the following parameters groups:

group 1 which comprises parameters whose values are derived from intra-frequency measurements carried on the wireless link;

group 2 which comprises parameters whose values are derived from inter-frequency measurements carried on links other than the current wireless link;

group 3 which includes parameters whose values are derived from inter-system measurements;

group 4 which includes parameters that relate to the managed entity's positioning measurements;

group 5 which comprises parameters that relate to measurements of traffic volume; and

group 6 which includes parameters that relate to results of the wireless link quality measurements.

Preferably, each of group 1 and/or group 2 includes one or more of the following parameters: CQI (Channel Quality Indicators), CINR (Carrier to Interferences and Noise Ratio) mean, CINR standard deviation, RSS (Received Signal Strength) mean, RSS standard deviation, timing adjustment, offset frequency adjustment and optimal transmission profile.

By still another preferred embodiment of the invention, group 3 includes one or more of the following parameters: current transmit power, maximum transmit power, power headroom, internal measurements on equipment associated with the managed entity.

According to yet another embodiment of the present invention, group 4 includes one or more parameters which relate to the managed entity positioning measurements. Examples of such parameters include: position indication using GPS or other triangular systems, time offset (propagation time), propagation loss, and the like.

By still another embodiment of the present invention, group 5 includes one or more parameters which relate to measurements of the traffic volume. Examples of such parameters include: amount or transmission unit (bit, packet, burst of packets, frame, blocks, and the like) transmitted successfully/failed, for every link, connection, session, etc. extending or held (as the case may be) between the managing and managed entities.

In accordance with another preferred embodiment of the invention, group 6 comprises one or more parameters which relate to the measurements of the quality of the link. Examples of such parameters include: Traffic Peak Rate/Peak Information Rate (PIR) with time base for calculation, traffic rate deviation, latency, jitter, loss ratio, Committed Information Rate (CIR) fulfillment, voice quality, grade of service indications, BER (bit error rate), PER (packet error rate), BlER (Block error rate), network KPI (Key Performance Indicators), amount of time that the terminal received information in a certain quality during a certain time period, information associated with connection switching, and the like.

Furthermore, it should be noted that the reporting rates could be modified based upon the connection conditions as decided on at the managing entity or at the managed entity, or both.

In accordance with still another embodiment of the invention, the updating information is transmitted from the managed entity in at least two different reporting rates, where each of the different reporting rates is associated with at least one different parameter than the other reporting rate. Preferably, these at least two different reporting rates (or at least some of the reporting rates) may be modified either independent of each other, or together.

By yet another embodiment of the invention, initiating or terminating the inclusion of indications that relate to certain parameter(s), is controlled by either one of the managed or managing entities.

By yet another embodiment of the invention, the step of determining a reporting rate by which the managed or managing entity should be transmitting the updating information, comprises applying a reporting ratio adaptation algorithm whose input is the updating information received and whose output is to dynamically change the rate at which the next information updates should be transmitted by the managed entity.

According to another aspect of the present invention there is provided a managing entity (e.g. a base station) adapted to operate in a wireless network and comprising:

an interface operative to allow communication between said managing entity and one or more managed entities (e.g. a subscriber terminal);

at least one radio transceiver operative to transmit wireless communication traffic towards the one or more managed entities and receive wireless communication traffic therefrom;

at least one processor adapted to:

derive updating information from transmissions received from the one or more managed entities along the wireless link, which includes indications of current resources available for the one or more managed entities and/or indications that relate to the reception of communications transmitted by the managing entity;

determine at least one reporting rate for transmitting reported parameters by which the one or more managed entities should be transmitting the updating information;

based on the at least one reporting rate determined for at least one of the parameters reported, modify, if necessary, parameters associated with the wireless link so as to affect changes in one or both ends of the wireless link;

prepare notifications for the one or more managed entities that indicate the at least one reporting rates at which proceeding information updates should be transmitted by the one or more managed entities.

Preferably, the reporting rate determined by the processor is determined in response to output received from a reporting ratio adaptation algorithm whose input is the updating information received from the managed entity (e.g. a subscriber terminal) and whose output is to dynamically change the reporting rate at which the next information updates should be transmitted by the managed entity.

According to still another preferred embodiment of the invention, the managing entity (e.g. the base station) is further adapted to manipulate any one or more of the following parameters, based upon the output of the reporting ratio adaptation algorithm:

a. level of quality of the services provided;

b. provisioning of services;

c. traffic flow; and

d. transmission pattern

In accordance with yet another aspect of the present invention, there is provided a managed entity (e.g. a subscriber terminal) adapted to operate in a wireless network and comprises:

an interface operative to allow communication between said managed entity and at least one managing entity;

at least one radio transceiver operative to transmit communication traffic and information updates towards the at least one managing entity and receive communication traffic therefrom;

at least one processor adapted to:

receive notifications from the at least one managing entity indicating a reporting rate at which proceeding information updates should be transmitted by the subscriber terminal towards the at least one managing entity.

Preferably, the notifications further include indications relating to modification of parameters associated with the wireless link so as to affect changes at the subscriber terminal's end of the wireless link.

By yet another embodiment of the invention, the at least one reporting rate can be determined based on values of reporting parameters received, and/or based on results of measurements preformed by the managing entity.

As previously explained, the reporting rate can be determined either at the managed entity or at the managing entity or at both (where in the latter case, each of the two entities should preferably be responsible for determining a reporting rate associated with a different reported parameter), based on reports and/or instructions received thereat.

### BRIEF DESCRIPTION OF THE DRAWINGS

FIG. 1—presents a schematic illustration of a wireless connection between a managed and a managing entity in accordance with an embodiment of the present invention; and

FIG. 2 illustrates schematically a wireless connection in accordance with an embodiment of the present invention.

### DETAILED DESCRIPTION OF THE INVENTION

A better understanding of the present invention is obtained when the following non-limiting detailed description is considered in conjunction with the following drawings in which:

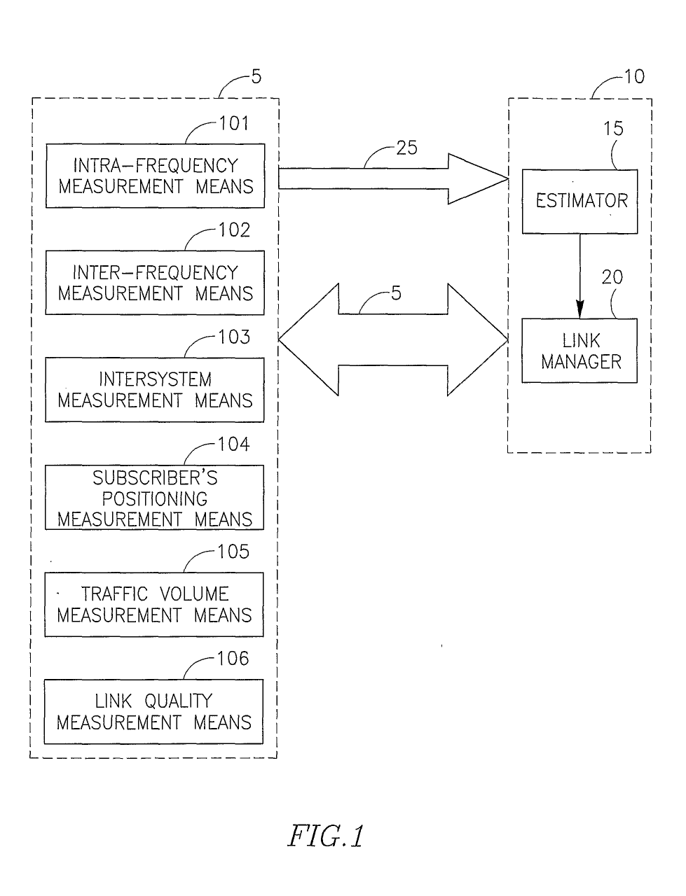

FIG. 1 presents a schematic presentation of an embodiment of the present invention, where there is a wireless communication connection (link) 5 extending between a terminal such as a subscriber terminal (or any other manageable entity) and a management entity such as a managing entity comprised in a Base Station (BS), where the latter includes an estimator 15 and link manager 20. According to certain prior art systems, the wireless terminal may send periodical, pre-defined reports to the base station (25). Or in other words, there is a constant reporting ratio defined as the number of communication blocks (frames) comprising the reported information to the number of blocks (frames) communicated by the terminal to the BS. Alternatively, any other periodic reporting methodology, not necessarily based on frames may be used. This constant pre-defined reporting ratio is set per unit (managed entity). It is determined upon carrying out the configuration of the unit, and may be modified, upon re-configuring the unit. The present invention, suggests a different approach, i.e. to dynamically apply a variable status reporting ratio, which may be changed for example in response to changes occurring and affecting the link status.

To achieve this goal, a managing entity 10, shown in this example as part of the BS, receives link status reports available to the subscriber terminal 5, based on parameters derived from the link extending between both entities. Estimator 15 is used to estimate, based on the available information, the frequency at which such reports should arrive at managing entity 10. Based on the information thus derived, link manager 20 determines the reporting ratio required, i.e. what should be the gap between the consecutive reporting frames, while the reporting is preformed for example in reporting messages constituting part of the frames. This information is conveyed to terminal 5, which in turn adapts its reporting rate accordingly. The estimation carried out by estimator 10, is done at any one of a few possible ways, such as on a continuous basis, on a periodic basis, etc. or at any other rate that the user will find fit as long as the estimator is able to keep track of the changes occurring at the terminal status and/or the link characteristics, as the case may be.

The reporting ratio determined by link manager 20 will preferably be dynamically tuned to maximize the effective reporting ratio by applying an appropriate reporting ratio algorithm.

Following is an example of parameters that may be used as the basis for determining the desired reporting ratio algorithm. The parameters presented are grouped into six categories, but as will be appreciated by those skilled in the art, not all of these categories must be used to derive successful algorithms, nor all of the parameters discussed must be used.

Group 1—Parameters whose values are derived from intra-frequency measurements carried out by intra-frequency measuring means 101 on the estimated channel that extends between the BS and the corresponding wireless terminal. Such optional parameters include: CQI, CINR mean, CINR standard deviation, RSS mean, RSS standard deviation, timing adjustment, offset frequency adjustment, optimal transmission profile, and the like, and any combination thereof.

Group 2—Parameters whose values are derived from inter-frequency measurements carried out by intra-frequency measuring means 102 on channels other than the estimated channel. Such optional parameters include: CQI, CINR mean, CINR standard deviation, RSSI mean, RSSI standard deviation, timing adjustment, offset frequency adjustment, optimal transmission profile, and the like, and any combination thereof.

Group 3—Parameters whose values are derived from intersystem measurements carried out by intersystem measuring means 103. Such optional parameters include: current transmit power, maximum transmit power, power headroom, internal measurements on the equipment, and the like and any combination thereof.

Group 4—Parameters that relate to the subscriber terminal's positioning measurements carried out by positioning measuring means 104. Examples of such parameters include: position indication using GPS or other triangular systems, time offset (propagation time), propagation loss, and the like.

Group 5—Parameters that relate to measurements of the traffic volume carried out by traffic volume measuring means 105. Examples of such parameters include the amount of transmission units (bit, packet, burst of packets, frames, blocks, and the like) transmitted successfully/failed, for every link, connection, session, etc. existing or in holding (as the case may be) between the managing and managed entities.

Group 6—Parameters that relate to the measurements of the quality of the link carried out by link quality measuring means 106. Examples of such parameters include: Traffic Peak Rate/PIR with the time base for calculation, traffic rate deviation, latency, jitter, loss ratio, CIR fulfillment, voice quality, grade of service indications, BER, PER, BlER, network KPI (Key Performance Indicators), the amount of time the terminal received information in certain quality during a certain time period, information associated with connection switching, and the like.

The reporting ratio adaptation algorithm may change dynamically the reporting ratio as a result of a change in the value of a single parameter (preferably such parameters will be a selected group out of all the parameters applied in the algorithm) or per group of parameters. Preferably, the reporting ratio will be set to the “maximal reporting ratio” based on pre-defined accuracy or availability level criteria, required by the user. Also, the estimation of “maximal reporting ratio” may be based on the reported values of some or all of the parameters or other indications, and changes according to the rate of change(s) occurring in the channel. For example, if the reported value is substantially constant (channel's characteristics remain constant or change relatively slowly) then the assessment mechanism would increase the gaps between consecutive reports (the reports cycle). On the other hand, if the reported value(s) change rapidly (the channel's characteristics undergo rapid changes), the assessment mechanism may decrease the gaps between consecutive reports.

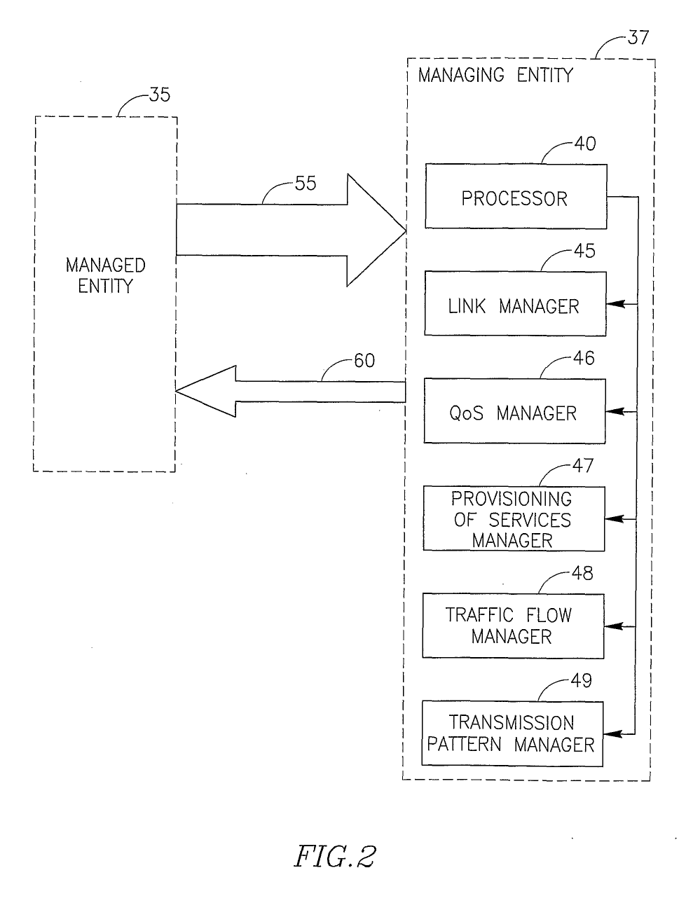

Let us now turn to FIG. 2 showing link managing entity 37 (e.g. BS, sector, resources manager) that is operative to manage link/connection parameters and shape according to periodic reports (55) received from the entity located at the other side of the link, 35. Although entity 35 will typically be a subscriber terminal, it should be appreciated that the present invention may also be carried out to some or other extent in the reverse direction, where the wireless terminal would receive information from the BS for instance, and will determine the rate at which it will transmit to the BS these periodic reports.

The managing entity receives the updates' reports and processor 40 is used to assess the maximal dynamic reporting ratio 60 to be applied. The assessed ratio is forwarded to manager 45 which in return is operative to manage the link/connection parameters and shape. In this example, it is illustrated that manager 45 is comprised of link manager 45, quality of service manager 46, provisioning of services manager 47, traffic flow manager 48 and transmission pattern manager 49. Thus, the management can be achieved by manipulating any one or combination of the following:

a. Level of quality of service (QoS) provided, e.g. that is allowed according to a signed service level agreement (SLA), while taking into consideration link connections, etc.

b. Available services (reduce or add available services, in accordance with the parameters determined);

c. Traffic flow (manipulate the pattern of the traffic flow of layer 3 and above type of traffic, in order to have it adapted to the wireless terminal's current capabilities)—for example by using the method provided by an embodiment of the invention, the priority of traffic flow/connection/sessions can be modified.

d. Transmission pattern (manipulate the pattern of transmission e.g. frame formation in layer 1 and slot/transmission opportunities allocation such as via the operation of layer 2 scheduler). Thus, according to an embodiment of the invention one or more of the following: the scheduling methodology (selection/prioritization between bits/blocks, packets, and transmission request that are waiting in the queues) or frame transmission block placement and amount of power that will be associated with this block upon its transmission by a terminal/BS, can be modified.

It is to be understood that the above description only includes some embodiments of the invention and serves for its illustration. Numerous other ways of managing various types of information exchanged in wireless telecommunication networks may be devised by a person skilled in the art without departing from the scope of the invention, and are thus encompassed by the present invention.

1-24. (canceled)

25. In a wireless network comprising at least one managing entity and at least one managed entity, operative to communicate which each other along a wireless link extending therebetween, a method for dynamically controlling transmission of communications, which method comprises:
from said at least one managed entity, transmitting along said wireless link updating information that comprises indications of current resources available at said managed entity and/or indications that relate to the reception of communications transmitted by said managing entity;
determining at least one reporting rate by which said managed entity should be transmitting said updating information to said managing entity;
based on said at least one reporting rate, determining if required to modify parameters associated with said wireless link, and if in the affirmative, modifying said parameters so as to affect changes in the operating conditions at one or both ends of said wireless link.

26. A method according to claim 25, wherein said step of determining at least one reporting rate, further comprises notifying said managed entity said at least one reporting rate at which the next information updates should be transmitted until further notification is received by said managed entity.

27. A method according to claim 25, further comprising a step wherein said managed entity modifies its at least one reporting rate, based on its current available resources and/or based on parameters relating to reception of communications transmitted by said managing entity.

28. A method according to claim 25, wherein said updating information is transmitted from said managed entity in at least two different reporting rates, wherein each of said different reporting rate is associated with at least one different parameter than the other reporting rate.

29. A method according to claim 25, wherein said updating information includes information that relates to at least one of the following parameters' groups:
group 1 which includes parameters whose values are derived from intra-frequency measurements carried on said wireless link;
group 2 which includes parameters whose values are derived from inter-frequency measurements carried on links other than the wireless link;
group 3 which comprises parameters whose values are derived from intersystem measurements;
group 4 which includes parameters that relate to the managed entity's positioning measurements;
group 5 which includes parameters that relate to measurements of traffic volume; and
group 6 which comprises parameters that relate to results of the wireless link quality measurements.

30. A method according to claim 29, wherein said group 1 comprises one or more of the following parameters: CQI, CINR mean, CINR standard deviation, RSS mean, RSS standard deviation, timing adjustment, offset frequency adjustment and optimal transmission profile.

31. A method according to claim 29, wherein said group 2 comprises one or more of the following parameters: CQI, CINR mean, CINR standard deviation, RSS mean, RSS standard deviation, timing adjustment, offset frequency adjustment and optimal transmission profile.

32. A method according to claim 29, wherein said group 3 comprises one or more of the following parameters: current transmit power, maximum transmit power, power headroom, internal measurements on equipment associated with said managed entity.

33. A method according to claim 29, wherein said group 4 comprises one or more of the following parameters: position indication, time offset and propagation loss.

34. A method according to claim 29, wherein said group 5 includes one or more of the following parameters: transmission unit selected from among burst, packet, and block, that has been transmitted successfully or that has failed, per link, connection and/or session.

35. A method according to claim 29, wherein said group 6 comprises one or more of the following parameters: traffic PIR, traffic rate deviation, latency, jitter, loss ratio, CIR fulfillment, voice quality, grade of service indications, BER, network KPI, the amount of time the terminal received information at a certain quality during a certain time period, and information associated with connection switching.

36. A method according to claim 25, wherein the step of determining at least one reporting rate by which said managed entity should be transmitting said updating information, includes applying a reporting ratio adaptation algorithm whose input is said updating information received from said managed entity and whose output is to dynamically change at least one reporting rate at which the next information updates should be transmitted by the managed entity.

37. A method according to claim 25, wherein said managing entity is further adapted to manipulate any one or more of the following parameters based upon the output of said reporting ratio adaptation algorithm: 1) level of quality of the services provided;
2) provisioning of services;
3) traffic flow; and
4) transmission pattern

38. A method according to claim 25, wherein said step of determining at least one reporting rate by which said managed entity should be transmitting said updating information, is carried out based on values of at least one of the parameters reported to said managing entity;

39. A method according to claim 25, wherein said step of determining at least one reporting rate by which said managed entity should be transmitting said updating information, is carried out based on values obtained in measurements of at least one of the operating parameters, conducted by said managing entity.

40. A method according to claim 25, wherein said step of determining at least one reporting rate by which said managed entity should be transmitting said updating information, is carried out based on instructions received from a source external to said managing entity and managed entity.

41. A managing entity adapted to operate in a wireless network and comprising:
an interface operative to allow communication between said managing entity and at least one managed entity;
at least one radio transceiver operative to transmit wireless communication traffic towards said at least one managed entity and receive wireless communication traffic therefrom;
at least one processor adapted to:
derive updating information from transmissions received from said at least one managed entity along said wireless link, which comprises indications of current resources available for said at least one managed entity and/or indications that relate to reception of communications transmitted by said managing entity;
determine at least one reporting rate for transmitting reported parameters by which said at least one managed entity should be transmitting said updating information;
based on the at least one reporting rate determined for at least one of reported parameters, modify, if required, parameters associated with said wireless link so as to affect changes in one or both ends of said wireless link;
prepare notifications for said at least one managed entity that indicate the at least one reporting rate at which proceeding information updates should be transmitted by said at least one managed entity.

42. A managing entity according to claim 41, wherein said updating information comprises information that relates to at least one of the following parameters' groups:
group 1 which comprises parameters whose values are derived from intra-frequency measurements carried on the wireless link;
group 2 which comprises parameters whose values are derived from inter-frequency measurements carried on links other than the current wireless link;
group 3 which includes parameters whose values are derived from inter-system measurements;
group 4 which includes parameters that relate to the managed entity's positioning measurements;
group 5 which comprises parameters that relate to measurements of traffic volume; and
group 6 which includes parameters that relate to results of the wireless link quality measurements.

43. A managing entity according to claim 41, wherein the at least one reporting rate determined by said processor is determined in response to output received from a reporting ratio adaptation algorithm whose input is said updating information received from said at least one managed entity and whose output is to dynamically change at least one of the reporting rates at which next information updates should be transmitted by said at least one managed entity.

44. A managing entity according to claim 43, further adapted to manipulate any one or more of the following parameters, based upon the output of said reporting ratio adaptation algorithm:
a. level of quality of the services provided;
b. provisioning of services;
c. traffic flow; and
d. transmission pattern

45. A manageable entity adapted to operate in a wireless network and comprising:
an interface operative to allow communication between said manageable entity and at least one base station managing entity;
at least one radio transceiver operative to transmit communication traffic and information updates towards said at least one managing entity and receive communication traffic therefrom;
at least one processor adapted to:
receive notifications from said at least one managing entity indicating at least one reporting rate at which proceeding information updates should be transmitted by said manageable entity towards said at least one managing entity.

46. A manageable entity according to claim 45, wherein said updating information comprises information that relates to at least one of the following parameters' groups:
group 1 which comprises parameters whose values are derived from intra-frequency measurements carried on the wireless link;
group 2 which comprises parameters whose values are derived from inter-frequency measurements carried on links other than the current wireless link;
group 3 which includes parameters whose values are derived from inter-system measurements;
group 4 which includes parameters that relate to the managed entity's positioning measurements;
group 5 which comprises parameters that relate to measurements of traffic volume; and
group 6 which includes parameters that relate to results of the wireless link quality measurements.

47. A manageable entity according to claim 45, wherein said notifications further comprise indications relating to modification of parameters associated with said wireless link so as to affect changes at the manageable entity's end of said wireless link.

48. A manageable entity according to claim 45, further adapted to manipulate any one or more of the following parameters: a. level of quality of the services provided;
b. provisioning of services;
c. traffic flow; and
d. transmission pattern.
